(19) United States
(12) Patent Application Publication
(10) Pub. No.: US 2008/0192622 A1
(43) Pub. Date: Aug. 14, 2008

(54) CONTROL CHANNEL SIGNALING IN A MULTIPLE ACCESS WIRELESS COMMUNICATION SYSTEM

(75) Inventors: Jacob Scheim, Pardes Hanna (IL); Ophir Shabtay, Haifa (IL)

Correspondence Address: Zaretsky Patent Group PC, 17505 N 79th Ave, Ste 211, Glendale, AZ, 85308-8726, US

(73) Assignee: Comsys Communication & Signal Processing Ltd.

(21) Appl. No.: 12/026,649

(22) Filed: Feb. 6, 2008

Related U.S. Application Data
(60) Provisional application No. 60/889,155, filed on Feb. 9, 2007.

(51) Int. Cl. H04J 11/00

(52) U.S. Cl. 370/210

(57) ABSTRACT

A novel and useful method and system for control channel signaling for use in multiple access wireless communication systems. The control message portion of the frame is divided into two portions: a first portion for transmitting a list of u-ID information and a second portion for transmitting all other remaining control information. All user identification information (u-ID information) is placed at the beginning of the control portion of a frame, typically in one or two symbols sent in the earliest part of the frame. The remaining control information (i.e. resource allocation and decoding information) is sent in the second portion of the control message. Users that do not have a resource assignment in a frame can skip the remainder of the frame, including the rest of the control message and data, and shutdown their receivers thus reducing power consumption. Only those UEs served in the current frame need to continue reception and decoding of the remainder of the control message and subsequent data.

### REFERENCE TO PRIORITY APPLICATION

This application claims priority to U.S. Provisional Application Ser. No. 60/889,155, filed Feb. 9, 2007, entitled “Signaling Method For Multiple Access Wireless Communication System,” incorporated herein by reference in its entirety.

### FIELD OF THE INVENTION

The present invention relates generally to wireless communication systems and more particularly relates to a method and system of control channel signaling for use in a multiple access wireless communication system.

### BACKGROUND OF THE INVENTION

Orthogonal Frequency Division Multiplexing (OFDM), a digital multi-carrier modulation scheme, is well known in the art. It uses a large number of closely spaced subcarriers that are orthogonal to each other. Each subcarrier is modulated with a conventional modulation scheme (e.g., quadrature amplitude modulation (QAM)) at a low symbol rate, maintaining data rates similar to conventional single carrier modulation schemes in the same bandwidth. The OFDM signals are typically generated using inverse fast Fourier transforms (IFFT) and fast Fourier transforms (FFT).

The primary advantage of OFDM over single-carrier schemes is its ability to cope with severe channel conditions, such as high frequency attenuation in copper wire, narrowband interference and frequency selective fading due to multipath, without the need for complex equalization filters in the receiver. Channel equalization is simplified because OFDM may be viewed as using many slowly modulated narrowband signals rather than one rapidly modulated wideband signal. The low symbol rate makes the use of a guard interval between symbols practicable, thereby making it possible to handle time spreading and eliminate intersymbol interference (ISI).

Orthogonal Frequency Division Multiple Access (OFDMA) is a multi-user version of the OFDM digital modulation scheme. Multiple access is achieved in OFDMA by assigning subsets of subcarriers to individual users. This permits simultaneous low data rate transmission from/to several users. Adaptive user to subcarrier assignment is achieved based on feedback information about channel conditions. If the assignment is performed quickly enough, the robustness of OFDM to fast fading and narrowband co-channel interference is improved, thereby making it possible to achieve even better system spectral efficiency. In practice, a different number of subcarriers can be assigned to different users, to support differentiated Quality of Service (QoS), i.e. to control the data rate and error probability individually for each user.

A diagram illustrating an example prior art multiple access wireless communications system is shown in FIG. 1. The system, generally referenced 10, comprises a base station 12 in wireless communication with a plurality of user equipment (UE) or mobile stations (MS) 16, labeled user equipment 1 through N. The base station transmits frames 14 to the UEs which comprise control information and data.

Currently, wireless mobile communication systems are evolving towards their forth generation (i.e. 4G networks). The evolution to 4G promises an increased number of users as well as an increase in user bandwidths. Along with an increase in mobility, these new systems will demand a substantial increase in system requirements.

Several new technologies are planning to be used to meet the increase in system requirements. One of these technologies is Orthogonal Division Multiple Access (OFDMA), a wireless technique proposed for WiMAX (IEEE 802.16e), WiFi (IEEE 802.11n), 3GPP-LTE and Ultra Mobile Broadband (UMB). Another technology for increasing system capacity (i.e. throughput, coverage, user rate, etc.) is known as ‘multiple-input multiple-output’ (MIMO) in which multiple transmit and receive antennas are used.

An OFDMA system is considered as an efficient modulation scheme which provides multiple access to a relatively large number of users with a relative simplicity by applying Fourier transform characteristics. In addition, at the receiver side, the OFDMA technology provides a relatively simple solution to the channel equalization problem. In operation, OFDMA implementation uses a fast-Fourier transform (FFT) algorithm which jointly modulates a large number of symbols over a large set of narrow band signals that are orthogonal to each other. The results of the FFT (in some cases inverse FFT or IFFT) form the basic transmission and reception element which is referred to as a symbol.

A block diagram illustrating a conventional OFDMA transceiver is shown in FIG. 2.

The example OFDMA transceiver, generally referenced 20, comprises a transmit path that includes a serial to parallel conversion 22, IFFT block 24, parallel to serial conversion 26, cyclic prefix insertion 28, shaping circuit 30, digital to analog converter (DAC) 32, upconversion mixer 34, transmitter/receiver (T/R) switch 36 and antenna 38. The receive path comprises downconversion mixer 42, analog to digital converter (ADC) 44, timing clock 46, cyclic prefix removal 48, serial to parallel conversion 50, FFT block 52 and demodulator 54. The transceiver also comprises frequency reference (f_{c}) 40 and controller 56.

The conventional approach in wireless communications is to provide a duplex mode where the uplink (UL or upstream) and the downlink (DL or downstream) coexists with a separation in time and/or in frequency, i.e. Time Division Duplex (TDD) and Frequency Division Duplex (FDD), respectively. In addition, it is also convention to divide the communication signals into time frames of constant lengths. For example, a TDD system utilizes a time frame for the UL where another time frame serves the DL. Both DL and UL comprise reception and transmission symbols, respectively, while the DL and UL time frames may differ in duration and signal characteristics (i.e. they are non-symmetric). Another example of duplexing is FDD where the UL and DL are simultaneously transmitted. In this case, the UL and DL differ in the frequency bands and may also differ in their corresponding bandwidth.

In addition to the UL and DL signals, the communication signal may incorporate zero or more preambles or system specific signals used for example for initial synchronization of joining users or new cells to the system. These types of signals may broadcast system related information.

A diagram illustrating the frame structure of a conventional OFDMA frame is shown in FIG. 3. The frame structure shown represents a conventional approach to the structure of the control message portion of the frame. The example system comprises a specific frame allocation having five resources, labeled R1-R5, assigned to users or groups of users indicated with u-ID1 through u-ID5, respectively. The control message comprises five consecutive elements each including the u-ID and the all other resource associated control information (e.g., resource assignment and associated transfer format). Note that, the control message may also be spread over the control message physical resource using an interleaver or randomized mapping function.

Each frame, generally referenced 60, in a multiple access communication system includes a signaling or control portion 62 where the system informs users (via the DL) or users inform the system (via the UL) on the transfer format used in the remainder of the frame. This signaling part may be considered as control signaling which is essential for the correct demultiplexing and demodulation of the payload data portion of the frame. Typically, the control signaling is placed with fixed timing with respect to the frame boundaries, usually near the beginning of the frame in a frame header comprising a plurality of symbols 69. Further, since the content of the control message is essential to the correct demodulation of the data part of the frame 64, which comprises the resources 68 assigned to users, the control message is usually encoded using strong error correction codes (ECC) in order to provide a high level of reliability. For additional reliability, the control message may also use a robust transmission scheme (i.e. using any combination of modulation, beam forming, transmit diversity or repetition techniques) which should increase the reliability of detection.

The control message incorporated within the frame may serve a variable number of users.

In this case, it is divided into several sub-messages 66 where each sub-message corresponds to a specific user or a group of users. The information incorporated in the sub-message helps the user (or group of users) to identify (1) the system resources scheduled for the user(s) and (2) the data transferring format to permit the correct demodulation of the associated resource.

A diagram illustrating the structure of the control message portion 130 of a conventional OFDMA frame is shown in FIG. 4. A more detailed description can be found in the 3rd Generation Partnership Project (3GPP), Technical Specification Group Radio Access Network, PHY Layer aspects for evolved Universal Terrestrial Radio Access (UTRA) (TR 25.814 V7.1.0), incorporated herein by reference.

The downlink control signaling comprises, for example, scheduling information for downlink data transmission, scheduling grants for uplink transmission and ACK/NAK indications in response to uplink transmission. Downlink scheduling information is used to inform the UE as to how to process downlink data. Typical information signaled to a ULE scheduled to receive user data is shown in FIG. 4.

With reference to FIG. 4, the control message comprises an indication 132 of the u-ID or group of u-IDs assigned resources in that frame. Resource related information may include (1) an indication or reference to the particular resource assigned 134 (e.g., time, frequency, space, etc. or any combination thereof) and (2) the time duration 136 the assignment is valid. The data transferring format information may comprise MIMO mode related data 138 to indicate that the content depends on particular MIMO schemes indicated as well as the modulation scheme 140 utilized for the assigned resource (e.g., QPSK, 16 QAM, 64 QAM), payload size 142 and HARQ information 144 to indicate the hybrid ARQ process the current transmission is addressing. All the information related to the resource assignment and transfer format is typically optimized and may utilize look up tables, formulas or other techniques to reduce signaling overhead.

Uplink scheduling grants are used to assign resources to UEs for uplink data transmission. The modulation and coding scheme used for the uplink transmission is implicitly given by the resource assignment and the transport format. Examples of the information signaled to a UE receiving an uplink scheduling grant includes: the u-ID indicating the UE or group of UEs for which the grant is intended, a resource assignment indicating which uplink resources the UE is permitted to use for uplink data transmission, assignment duration indicating the duration for which the assignment is valid and one or more transmission parameters comprising uplink transmission parameters the UE should use (e.g., modulation scheme, payload size, MIMO related information, etc.).

In both user specific association and group-based association, the control sub-message part of the frame 62 (FIG. 3) comprises information representing the identity of the user or group of users (referred to as u-ID in both cases). The u-ID element of information indicates an existing assignment of a corresponding resource(s) 68 to the u-ID.

Consider a multiple access wireless system whose transport is based on frames with a pre-defined structure, such as OFDMA. The frame structure, whether FDD, TDD or other scheme, specifies a certain time for (1) optional receive operation, (2) optional transmit operation, (3) measurement and (4) optional transmission of reference signals. A symbol is defined as the smallest transport element in the physical sense used to constitute a frame.

Each frame in the UL or the DL may serve a large set of users. One way to provide service to a large number of users is to (1) allocate a large portion of the system capacity for short periods, (2) allocate a small portion of the system capacity for larger periods or (3) provide dynamically changing allocations over time. In all these approaches, however, each user that expects to be served or to access a resource in the frame must first decode the entire control message in order to know whether or not it has been granted a resource assignment. Note that the access grant may also include information required for receive or transmit functionality.

Consider that in modern broadband multiple access systems, each symbol carries a very large number of bits. Moreover, the tasks that must be performed by the radio to transmit and receive are typically very complex and require large amounts of computation resources. This typically results in processing delays and the requirement of relatively large amounts of energy to transmit and receive a symbol. In such multiple access systems, therefore, it is desirable to minimize air access by users as much as possible.

Since the control message may be spanned over several symbols in time, however, the constraint above mentioned may require operation of the receiver for a large number of symbols. This results in increased operation time for the receiver which causes a significant increase in power consumption and consequent reduction in receiver standby time. This is a major concern particularly for mobile receivers but may also affect fixed receivers located in the base stations.

Depending on the implementation, prior art control signaling can be organized in different ways depending on the number of users serviced, their application, network optimizing criterions, etc. In one example, the users or group of users does not change over time (i.e. is the same frame after frame), except for possibly minor changes when a user begins or ends a network service, which we neglect here for simplicity. In this example, all control signaling to all users is signaled each frame and every frame. This mode of operation is permitted but is very inefficient from the network perspective since the control signaling overhead is considerably high and network efficiency is greatly reduced. In this case, all users demodulate the entire control message, eventually receive the corresponding allocation, modulation and decoding related in formation and finally decodes the associated resources of data. In this case we don't have much to do.

A more practical mode of operation is to serve a portion of the users each frame, whereby all users are eventually served over a super frame cycle (i.e. a set of consecutive frames). The latency generated in this mode is negligible since the super frame is sufficiently short. Using this technique, the control signaling burden is reduced substantially, to the level necessary to serve only a portion of the users. For example, each frame may serve a half, a quarter or up to one tenth of the control information required compared to the previous approach. In this case, only a portion of the users actually get an allocation at each frame (e.g., one tenth). At each frame, however, all users are obligated to decode the entire control signaling, even if there are no resource allocations assigned to them in that particular frame.

In the prior art, the control message information for each user is uniformly distributed over the entire control signaling region of the frame which may take up to three symbols in the 3GPP-LTE standard and is practically unlimited in WiMAX. All users connected to the cell must receive and decode the entire control message region. After receiving the control message a user searches for its corresponding u-IDs spread across the entire control message. The rest of the control message decoding may be eliminated if the u-ID does not appear in the control message. The decoding may be performed on the fly along with reception. Reception of the entire control message, however, is still unavoidable.

Thus, there is a need for a mechanism that is capable of reducing the power consumption for radio receivers in a multiple access wireless system. The mechanism preferably enables the level of control signaling needed to be received and decoded to be reduced to a minimum level. In addition, the mechanism should preferably be able to minimize the air access time of such receivers, thereby reducing power consumption without incurring a loss in performance or quality of reception.

### SUMMARY OF THE INVENTION

Accordingly, the present invention provides a novel and useful method and system for control channel signaling for use in multiple access wireless communication systems. The control channel signaling mechanism of the present invention is operative to reduce power consumption for users that are not served in a current frame. This is achieved by minimizing the number of OFDMA symbols that UEs not served in a current frame are still required to receive, decode and interpret. Only UEs served in the current frame are required to receive, decode and interpret the entire control channel message.

In the mechanism of the present invention, a user receives and decodes only a first portion of the control channel signaling which contains a list of u-IDs served in that particular frame. This list is typically transmitted in one or two OFDM symbols at the earliest part of the frame. If a user's u-ID does not appear in the list, it may shut off its associated receiver circuitry and keep its transmitter circuitry off as well until the following frame. This provides a significant benefit in terms of ‘stand-by time’ (or ‘hold time’) and ‘on time’ (or ‘talk time’) since the ability to shut the receiver off earlier significantly reduces power consumption. All users sharing a cell transmission receive and decode the list of users (u-ID information) before continuing to receive and decode the remainder of the control channel message, which is eventually followed by data reception or transmission. It is noted that the control signaling is also used to allocate up-link (UL) resources for transmission typically in the next frame. In FDD schemes TX and RX frames are transmitted concurrently. In TDD schemes, however, they are fixed TX after RX.

In accordance with the invention, the control message portion of the frame is divided into two portions: a first portion for transmitting a list of u-ID information and a second portion for transmitting all other remaining control information. All user identification information (u-ID information) is placed at the beginning of the control portion of a frame. Preferably, it is placed in the first OFDM symbol (i.e. transmitted in the earliest part of the frame). If the list of u-ID information cannot fit in a single symbol, additional symbols are used until all the u-ID information is transmitted. The remaining control information (i.e. resource allocation and decoding information) is sent in the second portion of the control message.

The control channel signaling mechanism of the present invention is suitable for use in many types of wireless communication systems. For example, the mechanism is applicable to broadband wireless access (BWA) systems and cellular communication systems, particularly OFDM based systems. An example of a broadband wireless access system the mechanism of the present invention is applicable to is the well known WiMAX wireless communication standard. The mechanism of the invention is also applicable to one of the third-generation (3G) mobile phone technologies known as 3GPP-LTE, Universal Mobile Telecommunications System (UMTS), Code Division Multiple Access (CDMA), Enhanced Data rates for GSM Evolution (EDGE) and Wireless Local Area Network (WLAN) wireless communication systems. The invention is also applicable to fourth generation (4G) mobile technologies, Digital Video Broadcasting (DVB) standards, Ultra Wideband (UWB), Ultra Mobile Broadband (UMB) and IEEE 802.11g/a.

Many aspects of the invention described herein may be constructed as software objects that execute in embedded devices as firmware, software objects that execute as part of a software application on either an embedded or non-embedded computer system running a real-time operating system such as Windows mobile, WinCE, Symbian, OSE, Embedded LINUX, etc., or non-real time operating systems such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the invention, a method of control channel signaling for use in a transmitter, the method comprising the step of transmitting user-ID information addressed in a current frame as a decodable entity at the beginning of the current frame thereby enabling receivers to cease continued reception of the current frame if their respective user-IDs have no corresponding assignment therein.

There is also provided in accordance with the invention, a method of control channel signaling for use in a transmitter, the method comprising the steps of first transmitting a list of all user-ID information addressed in a current frame as a first decodable entity encoded into one or more codewords sent at the beginning of the current frame, second transmitting other control information for the current frame as one or more second decodable entities encoded into one or more codewords sent subsequent to the first decodable entity and third transmitting other data subsequent to the one or more second decodable entities.

There is further provided in accordance with the invention, a method of control channel signaling for use in a receiver, the method comprising the steps of receiving a list of user-ID information addressed in a current frame as a first decodable entity encoded into one or more codewords sent at the beginning of the current frame and continuing to receive the current frame if a corresponding user-ID assignment is found in the list, otherwise ceasing reception of the current frame.

There is also provided in accordance with the invention, a radio comprising a transmitter, a receiver, a baseband processor coupled to the transmitter and the receiver and a control channel signaling unit coupled to the transmitter and operative to transmit user-ID information addressed in a current frame as a decodable entity at the beginning of the current frame thereby enabling the receiver to cease continued reception of the current frame if its respective user-ID has no corresponding assignment therein.

There is further provided in accordance with the invention, a radio comprising a transmitter, a receiver, a baseband processor coupled to the transmitter and the receiver, a control channel signaling unit coupled to the receiver and operative to receive a list of all user-ID information addressed in a current frame as a first decodable entity encoded into one or more codewords sent at the beginning of the current frame and continue to receive the current frame if a corresponding user-ID assignment is found in the list, otherwise ceasing reception of the current frame.

### BRIEF DESCRIPTION OF THE DRAWINGS

The invention is herein described, by way of example only, with reference to the accompanying drawings, wherein:

FIG. 1 is a diagram illustrating an example prior art multiple access wireless communications system;

FIG. 2 is a block diagram illustrating a conventional OFDMA transceiver;

FIG. 3 is a diagram illustrating the frame structure of a conventional OFDMA frame;

FIG. 4 is a diagram illustrating the structure of the control message portion of a conventional OFDMA frame;

FIG. 5 is a general block diagram illustrating an example radio incorporating the control channel signaling mechanism of the present invention;

FIG. 6 is a general block diagram illustrating a mobile station incorporating the control channel signaling mechanism of the present invention;

FIG. 7 is a diagram illustrating a first structure of the control message of the present invention in more detail;

FIG. 8 is a diagram illustrating the frame structure of an OFDMA frame modified in accordance with the present invention;

FIG. 9 is a diagram illustrating the frame structure of an example OFDMA frame adapted for use with the control channel signaling mechanism of the present invention;

FIG. 10 is a diagram illustrating a second structure of the control message of the present invention in more detail;

FIG. 11 is a block diagram illustrating an example OFDMA transmitter incorporating the control channel signaling mechanism of the present invention;

FIG. 12 is a flow diagram illustrating the transmitter based control channel signaling method of the present invention; and

FIG. 13 is a flow diagram illustrating the receiver based control channel signaling method of the present invention.

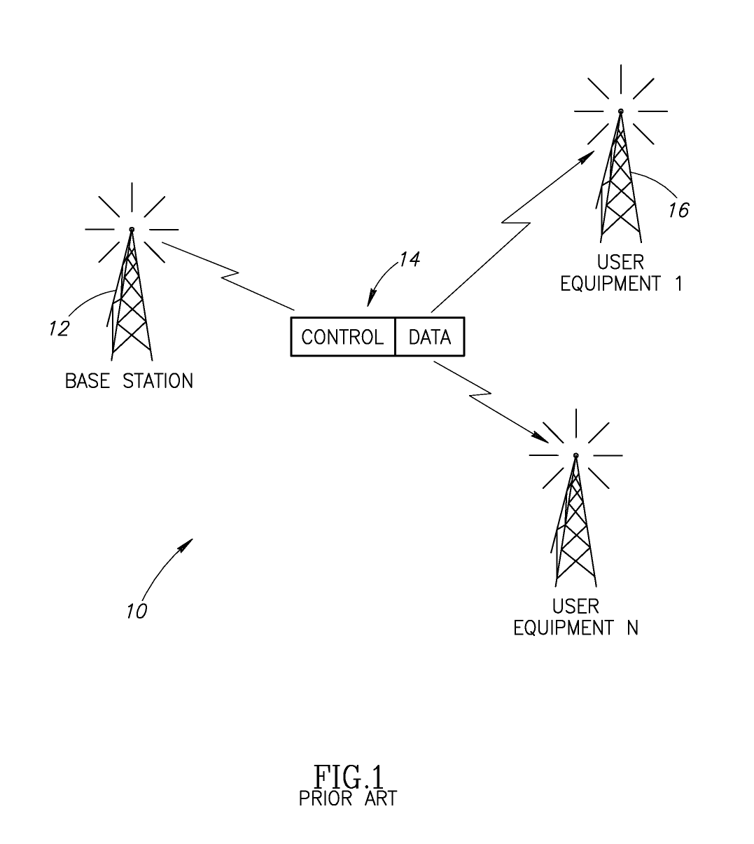

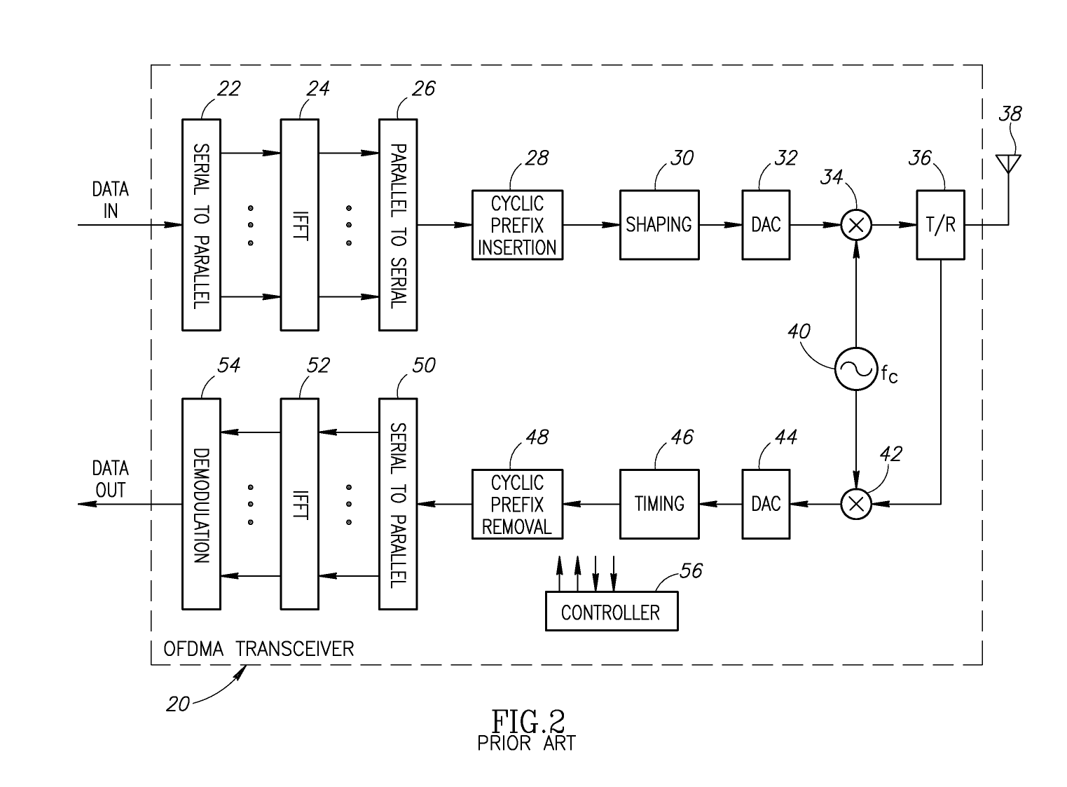

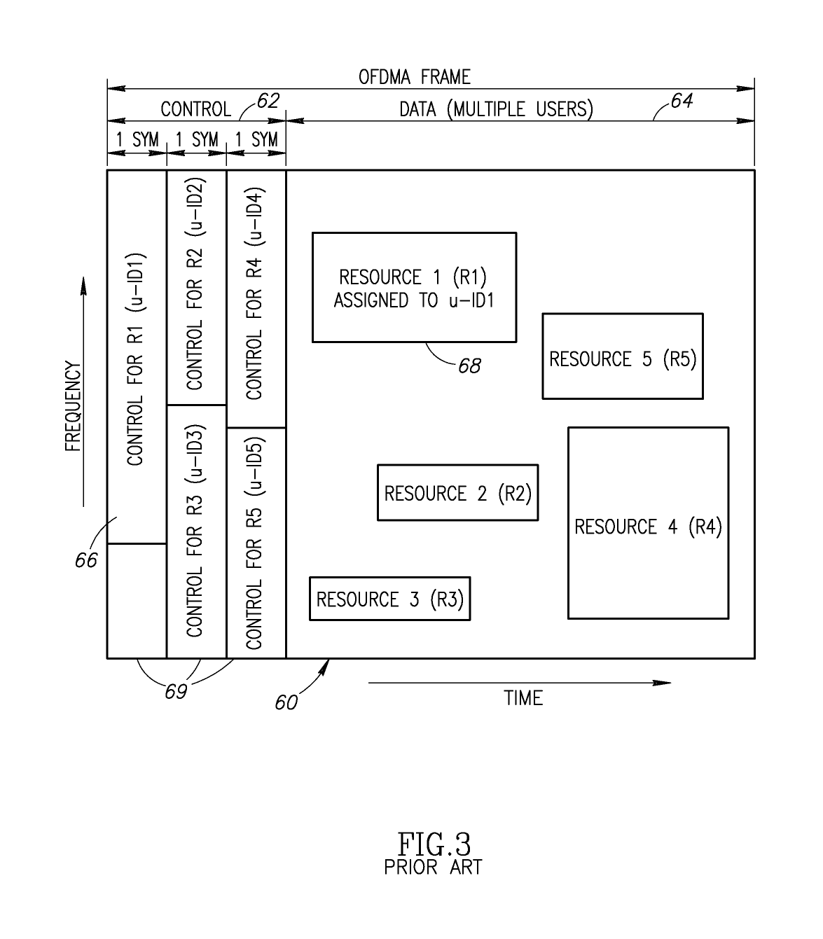

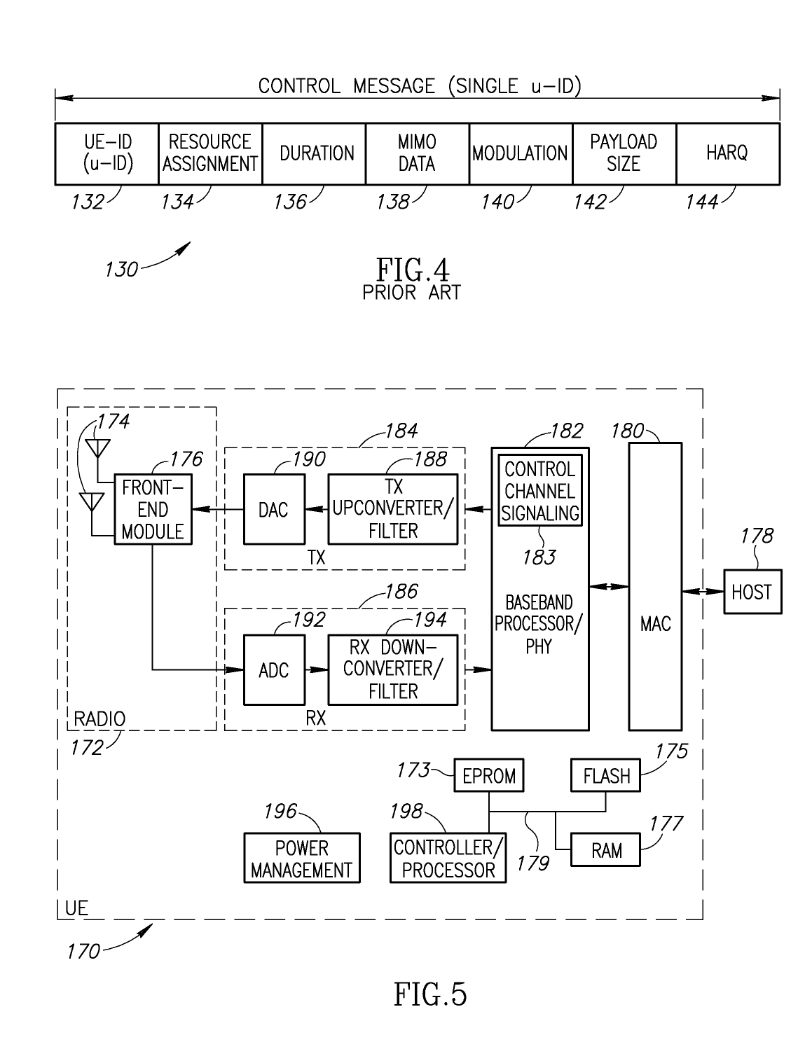

### DETAILED DESCRIPTION OF THE INVENTION

### Notation Used Throughout

The following notation is used throughout this document.

| Term | Definition |
|---|---|
| AAA | Authentication Authorization and Accounting |
| AC | Alternating Current |
| ADC | Analog to Digital Converter |
| ARQ | Automatic Repeat Request |
| ASIC | Application Specific Integrated Circuit |
| AVI | Audio Video Interface |
| BMP | Windows Bitmap |
| BWA | Broadband Wireless Access |
| CDMA | Code Division Multiple Access |
| CP | Cyclic Prefix |
| CPU | Central Processing Unit |
| DAC | Digital to analog Converter |
| DC | Direct Current |
| DL | Downlink |
| DRAM | Dynamic Random Access Memory |
| DVB | Digital Video Broadcast |
| ECC | Error Correction Code |
| EDGE | Enhanced Data rates for GSM Evolution |
| EEPROM | Electrically Erasable Programmable Read Only Memory |
| EPROM | Erasable Programmable Read Only Memory |
| EVDO | Evolution-Data Optimized |
| FDD | Frequency Division Duplex |
| FEC | Forward Error Correction |
| FEM | Front End Module |
| FFT | Fast Fourier Transform |
| FM | Frequency Modulation |
| FPGA | Field Programmable Gate Array |
| GPRS | General Packet Radio Service |
| GPS | Global Positioning Satellite |
| GSM | Global System for Mobile Communication |
| HARQ | Hybrid Automatic Repeat Request |
| HDL | Hardware Description Language |
| ID | Identification |
| IEEE | Institute of Electrical and Electronic Engineers |
| IFFT | Inverse Fast Fourier Transform |
| ISI | Intersymbol Interference |
| JPG | Joint Photographic Experts Group |
| KPI | Key Performance Indicators |
| LAN | Local Area Network |
| LSB | Least Significant Bit |
| MAC | Media Access Control |
| MIMO | Multiple In Multiple Out |
| MP3 | MPEG-1 Audio Layer 3 |
| MPG | Moving Picture Experts Group |
| MS | Mobile Station |
| MSB | Most Significant Bit |
| OFDMA | Orthogonal Frequency Division Multiple Access |
| OSI | Open System Interconnect |
| PC | Personal Computer |
| PCI | Peripheral Component Interconnect |
| PDA | Personal Digital Assistant |
| QAM | Quadrature Amplitude Modulation |
| QPSK | Quadrature Phase Shift Keying |
| RAM | Random Access Memory |
| RAN | Radio Access Network |
| RAT | Radio Access Technology |
| RF | Radio Frequency |
| ROM | Read Only Memory |
| SDIO | Secure Digital Input/Output |
| SIM | Subscriber Identity Module |
| SPI | Serial Peripheral Interface |
| SRAM | Static Read Only Memory |
| TDD | Time Division Duplex |
| TV | Television |
| UE | User Equipment |
| u-ID | User (or group of users) Identification code |
| UL | Uplink |
| UMB | Ultra Mobile Broadband |
| UMTS | Universal Mobile Telecommunications System |
| USB | Universal Serial Bus |
| UTRA | Universal Terrestrial Radio Access |
| UWB | Ultra Wideband |
| WCDMA | Wideband Code Division Multiple Access |
| WiFi | Wireless Fidelity |
| WiMAX | Worldwide Interoperability for Microwave Access |
| WiMedia | Radio platform for UWB |
| WLAN | Wireless Local Area Network |
| WMA | Windows Media Audio |
| WMV | Windows Media Video |
| WPAN | Wireless Personal Area Network |

### DETAILED DESCRIPTION OF THE INVENTION

The present invention provides a novel and useful method and system for control channel signaling for use in multiple access wireless communication systems. The control channel signaling mechanism of the present invention is operative to reduce power consumption for users that are not served in a current frame. This is achieved by minimizing the number of OFDMA symbols that UEs not served in a current frame are still required to receive, decode and interpret. Only UEs served in the current frame are required to receive, decode and interpret the entire control channel message.

In the mechanism of the present invention, a user receives and decodes only a first portion of the control channel signaling which contains a list of u-IDs served in that particular frame. This list is typically transmitted in one or two OFDM symbols at the earliest part of the frame. If a user's u-ID does not appear in the list, it may shut its associated receiver circuitry off and keep its transmit circuitry off as well until the following frame. This provides a significant benefit in terms of ‘stand-by time’ (or ‘hold time’) and ‘on time’ (or ‘talk time’) since the ability to shut the receiver off earlier significantly reduces power consumption. All users sharing a cell transmission receive and decode the list of users (u-ID information) before continuing to receive and decode the remainder of the control channel message, which is eventually followed by data.

The control channel signaling mechanism of the present invention is suitable for use in many types of wireless communication systems. For example, the mechanism is applicable to broadband wireless access (BWA) systems and cellular communication systems, particularly OFDM (and OFDMA), single carrier frequency division multiple access (SC-FDMA), linear precoded OFDMA (LP-OFDMA) and other wideband signaling based systems. An example of a broadband wireless access system the mechanism of the present invention is applicable to is the well known WiMAX wireless communication standard. The mechanism of the invention is also applicable to one of the third-generation (3G) mobile phone technologies known as Universal Mobile Telecommunications System (UMTS), 3GPP Long Term Evolution (3GPP-LTE), Code Division Multiple Access (CDMA), Enhanced Data rates for GSM Evolution (EDGE) and Wireless Local Area Network (WLAN) wireless communication systems. The invention is also applicable to fourth generation (4G) mobile technologies, Digital Video Broadcasting (DVB) standards, Ultra Wideband (UWB), Ultra Mobile Wideband (UMB) and IEEE 802.11n/g/a.

To aid in illustrating the principles of the present invention, the control channel signaling mechanism is presented in the context of an OFDMA communications system. It is not intended that the scope of the invention be limited to the examples presented herein. One skilled in the art can apply the principles of the present invention to numerous other types of communication systems as well (wireless and non-wireless) without departing from the scope of the invention.

Note that throughout this document, the term communications transceiver or device is defined as any apparatus or mechanism adapted to transmit, receive or transmit and receive information through a medium. The communications device or communications transceiver may be adapted to communicate over any suitable medium, including wireless or wired media. Examples of wireless media include RF, infrared, optical, microwave, UWB, Bluetooth, WiMAX, GSM, EDGE, UMTS, WCDMA, 3GPP-LTE, CDMA-2000, EVDO, EVDV, UMB, WiFi, or any other broadband medium, radio access technology (RAT), etc. Examples of wired media include twisted pair, coaxial, optical fiber, any wired interface (e.g., USB, Firewire, Ethernet, etc.). The terms communications channel, link and cable are used interchangeably. The terms mobile station (MS) and user equipment (UE) is defined as all user equipment circuitry and associated software needed for communication with a network such as a RAN. The terms mobile station and user equipment are also intended to denote other devices including, but not limited to, a multimedia player, mobile communication device, cellular phone, node in a broadband wireless access (BWA) network, smartphone, PDA, wireless LAN (WLAN) and Bluetooth device. Although a mobile station or user equipment are normally intended to be used in motion or while halted at unspecified points but, the terms as used herein also refers to devices fixed in their location. The term u-ID (i.e. user ID) refers to information representing the identity of a user or group of users.

The word ‘exemplary’ is used herein to mean ‘serving as an example, instance, or illustration.’ Any embodiment described herein as ‘exemplary’ is not necessarily to be construed as preferred or advantageous over other embodiments.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.) and/or other content widely identified as multimedia. The user input means is typically formed of one or more manually operated switches, buttons, wheels or other user input means. Examples of multimedia devices include pocket sized personal digital assistants (PDAs), personal media player/recorders, cellular telephones, handheld devices, and the like.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In one embodiment, a portion of the mechanism of the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

### Radio Incorporating the Control Channel Signaling Mechanism

A general block diagram illustrating an example UE incorporating the control channel signaling mechanism of the present invention is shown in FIG. 5. The UE, generally referenced 170, comprises a radio block 172 comprising RF front end module (FEM) 176 coupled to one or more antennas 174 (typically at least two in BWA systems), transmitter block 184 and dual receiver block 186 coupled to the FEM 176 and baseband processor/PHY 182, MAC 180, power management block 196, a controller/processor 198 coupled to ROM memory 173, Flash 175 and RAM 177. The transmitter block 184 comprises TX upconversion and filtering block 188 and DAC 190. The receiver block 186 comprises ADC block 192 and RX downconversion and filtering block 194.

A host interface (not shown) functions to interface the UE via the MAC to a host entity 178. The host may comprise any suitable computing device such as a PDA, laptop computer, desktop computer, handheld telecommunications device, etc. The host interface may be adapted to communicate with the host in any manner. Typically, the host interface is adapted to communicate via a standard interface including, but not limited to, PCI, CardBus, USB, SDIO, SDI, etc.

The media access controller (MAC) 180 is operative to provide Layer 2 functionality. The main services and functions of the MAC sublayer includes mapping between logical and transport channels, multiplexing and demultiplexing of radio link control (RLC) PDUs belonging to one or different radio bearers into/from transport blocks (TB) delivered to/from the physical layer on transport channels, traffic volume measurement reporting, error correction through HARQ, priority handling between logical channels of one UE, priority handling between UEs by means of dynamic scheduling and transport format selection. The baseband processor/PHY module 182 performs modulation and demodulation of data (i.e. OFDM in the case of WLAN 802.11n/a/g, WiMAX, UWB, etc. capable radio). The baseband processor also handles the transmission and reception of frames to and from the TX and RX, respectively. Analog to digital (ADC) and digital to analog (DAC) conversion are performed in the receiver and transmitter, respectively. The FEM 176, coupled to antenna 174, performs radio frequency (RF) processing including filtering, optional down-conversion and up-conversion and amplification of the RF signal.

In accordance with the present invention, the control channel signaling mechanism of the present invention is implemented in the radio. Depending on the particular implementation, the control channel signaling mechanism (block 183) may be implemented in the baseband processor/PHY block 182, the MAC 180, as a task adapted to execute on the controller 198, etc. For illustration purposes only, the control channel signaling mechanism is shown incorporated in the MAC. It is appreciated that the control channel signaling mechanism may be implemented in other components of the radio as well without departing from the spirit of the invention. In the case the mechanism of the invention is implemented as a task executed on the processor/controller, the programming code for implementing the mechanism may reside in memories 173, 175 or 177 within the radio or in internal memory within the processor/controller 198 itself. Note also that the mechanism may be performed entirely in hardware, software or a combination of hardware and software. Alternatively, the mechanism may be implemented entirely in the host or a portion implemented in the host and a portion in the MAC.

The processor/controller 198 in the radio is coupled to also comprises a, flash memory 175, static random access memory (SRAM) 177 and electrical erasable programmable read only memory (EEPROM) 173. Note that DRAM may be used in place of static RAM. The controller 198 is operative to provide management, administration and control to the MAC, baseband processor, PHY and TX, RX modules. The controller is also in communication with the Flash, SRAM and EEPROM memories via a memory bus 179 or via a single bus (not shown) shared by all the modules and memory devices.

### Mobile Station Incorporating the Control Channel Signaling Mechanism

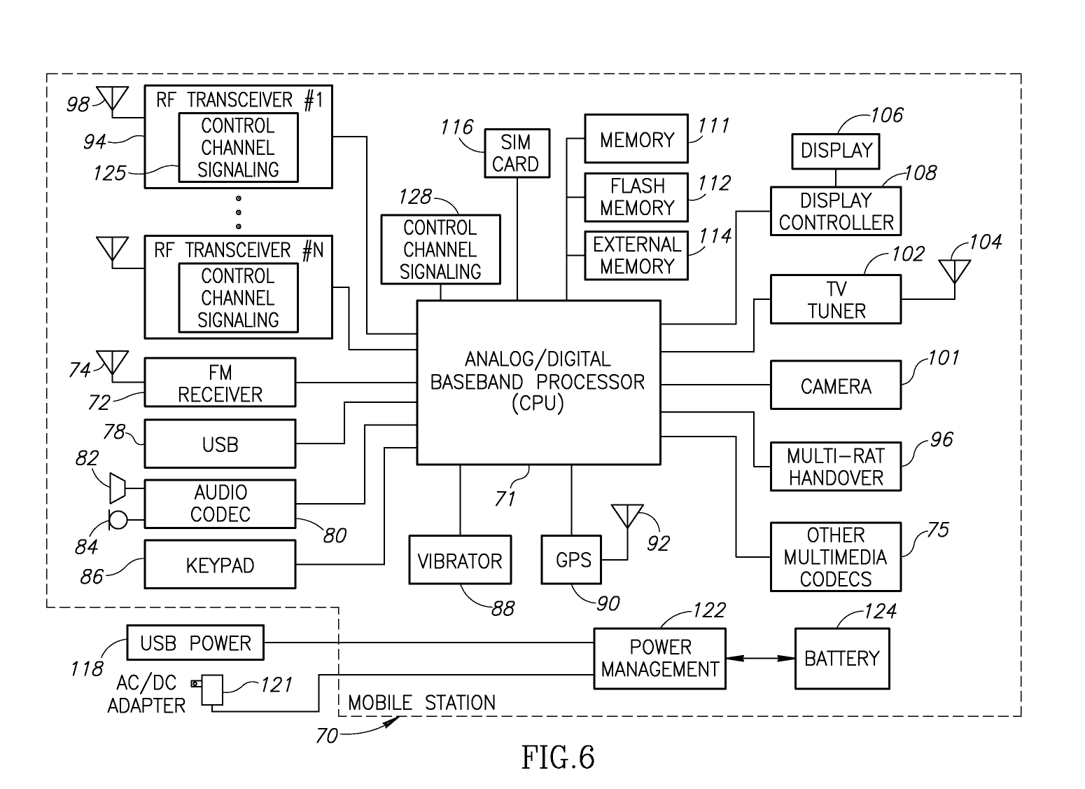

A general block diagram illustrating a mobile station incorporating the control channel signaling mechanism of the present invention is shown in FIG. 6. Note that the mobile station (also referred to as user equipment) may comprise any suitable wired or wireless device such as multimedia player, mobile communication device, cellular phone, smartphone, PDA, Bluetooth device, etc. For illustration purposes only, the device is shown as a mobile station. Note that this example is not intended to limit the scope of the invention as the control channel signaling mechanism of the present invention can be implemented in a wide variety of communication devices.

The mobile station, generally referenced 70, comprises a baseband processor or CPU 71 having analog and digital portions. The MS may comprise a plurality of RF transceivers 94 and associated antennas 98. RF transceivers for the basic cellular link and any number of other wireless standards and RATs may be included. Examples include, but are not limited to, Global System for Mobile Communication (GSM)/GPRS/EDGE 3G; CDMA; WiMAX for providing WiMAX wireless connectivity when within the range of a WiMAX wireless network using OFDMA techniques; Bluetooth for providing Bluetooth wireless connectivity when within the range of a Bluetooth wireless network; WLAN for providing wireless connectivity when in a hot spot or within the range of an ad hoc, infrastructure or mesh based wireless LAN network; near field communications; 60G device; UWB; etc. One or more of the RF transceivers may comprise an additional a plurality of antennas to provide antenna diversity which yields improved radio performance. The mobile station may also comprise internal RAM and ROM memory 110, Flash memory 112 and external memory 114.

Several user interface devices include microphone(s) 84, speaker(s) 82 and associated audio codec 80 or other multimedia codecs 75, a keypad for entering dialing digits 86, vibrator 88 for alerting a user, camera and related circuitry 100, a TV tuner 102 and associated antenna 104, display(s) 106 and associated display controller 108 and GPS receiver 90 and associated antenna 92. A USB or other interface connection 78 (e.g., SPI, SDIO, PCI, etc.) provides a serial link to a user's PC or other device. An FM receiver 72 and antenna 74 provide the user the ability to listen to FM broadcasts. SIM card 116 provides the interface to a user's SIM card for storing user data such as address book entries, etc. Note that the SIM card shown is intended to represent any type of smart card used for holding user related information such as identity and contact information, Authentication Authorization and Accounting (AAA), profile information, etc. Different standards use different names, for example, SIM for GSM, USIM for UMTS and ISIM for IMS and LTE.

The mobile station comprises control channel signaling blocks 125 which may be implemented in any number of the RF transceivers 94. Alternatively (or in addition to), the control channel signaling block 128 may be implemented as a task executed by the baseband processor 71. The control channel signaling blocks 125, 128 are adapted to implement the control channel signaling mechanism of the present invention as described in more detail infra.

In operation, the control channel signaling blocks may be implemented as hardware, software or as a combination of hardware and software. Implemented as a software task, the program code operative to implement the control channel signaling mechanism of the present invention is stored in one or more memories 110, 112 or 114 or local memories within the baseband processor.

Portable power is provided by the battery 124 coupled to power management circuitry 122. External power is provided via USB power 118 or an AC/DC adapter 120 connected to the battery management circuitry which is operative to manage the charging and discharging of the battery 124.

### Control Channel Signaling Mechanism

The present invention achieves the goal of reducing power consumption of the receiver in the radio by dividing the control message into two portions: (1) a first portion comprising a list of the user-ID (or u-ID) portion assigned (i.e. involved or associated) with that particular current frame and (2) a second portion comprising all other remaining control information. The first portion, i.e. the list of u-IDs involved in the current frame, comprises a plurality of u-IDs wherein u-ID comprises a specific signature that functions to map a resource definition to a particular terminal, user equipment (UE) or a group of users that share the same u-ID and transport format. The second portion comprises the resource related information and transport format information.

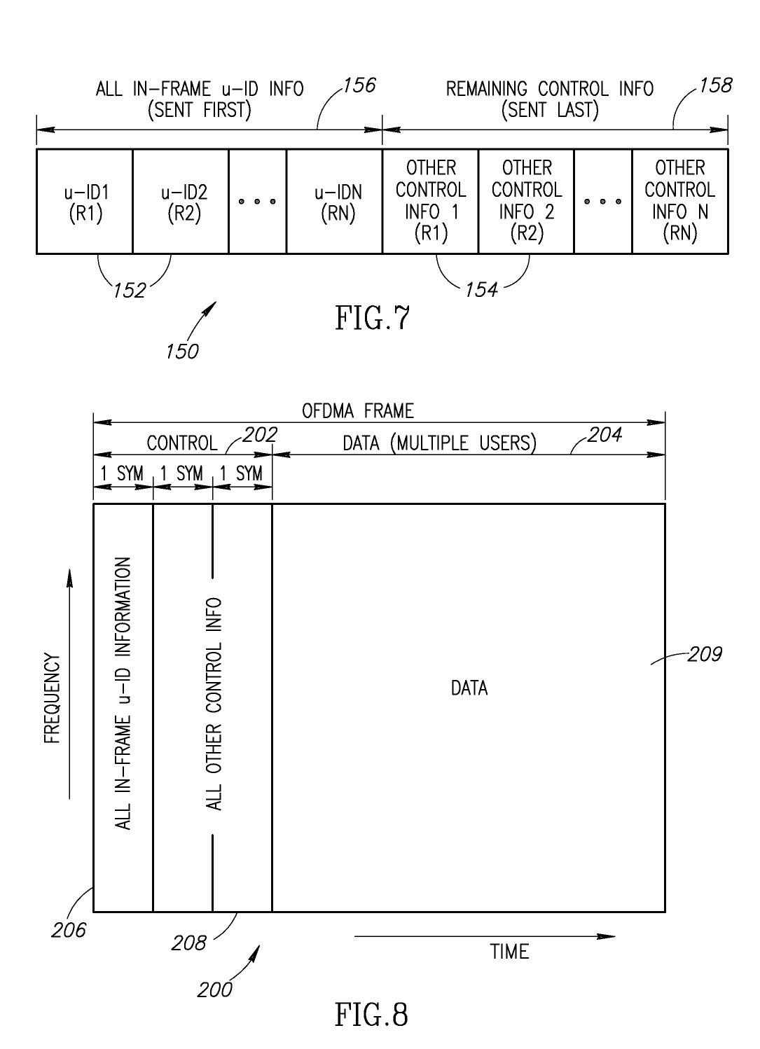

A diagram illustrating a first structure of the control message of the present invention in more detail is shown in FIG. 7. The control message, generally referenced 150, comprises two portions: a list of all the in-frame u-ID information 156 and the remaining control information 158.

The plurality of u-IDs 152 are transmitted together in serial fashion one after the other in the first part of the frame (i.e. sent earliest). The plurality of u-IDs 152 form a reliably decodable entity, regardless of the remaining control information 154 or the remaining data in the frame. Similarly, the remaining control information 154 (e.g., resource related information) is transmitted subsequent to the u-ID information 156 (i.e. sent subsequent to the first portion or latest in time within the control message). Each of the u-IDs corresponds to a resource (e.g., R1 through RN) that is sent in the current frame.

A diagram illustrating the frame structure of an OFDMA frame modified in accordance with the present invention is shown in FIG. 8. Each frame, generally referenced 200, comprises a signaling or control portion 202 and a data portion 204. Note that the frame normally comprises both a DL and UL portion where in respect to the UL portion, the system informs users (via the DL control signaling) or users inform the system (via the UL control signaling if any) on the transfer format used in the UL part of the frame. For clarity, however, only the DL portion is shown in the frame examples presented herein.

As described above, a conventional OFDMA frame is divided into two parts. The first part being the control part and the second part being the data carrying part. The control part comprises the information required for users to detect the assigned resources to the user (if any) and decode them. It is noted that by convention, the control signal information is valid for the current frame only. There may, however, be additional modes of operation whereby the control signaling is valid for a larger time window (e.g., multiple frames). A multiple frame transmission is referred to as a super-frame and is the largest time period for which the control information is valid. When a frame or a super frame ends, new control information must be transmitted in order to allocate new resources (as the resource allocation be completely different than the previous allocation) with corresponding modulation and coding schemes to possibly different users or group of users.

It is noted that the control signaling modified by the present invention is related to the resource allocation, demodulation and decoding of the signal transmitted to a specific user or a group of users. Higher level control for serving higher layers such as mobility control, application level control, etc. may be signaled through the data portion of the frame and lasts considerably longer than the low level control the invention is related to (i.e. the invention is mainly applicable to allocation in space, time and frequency, demodulation and decoding.

The control message incorporated within the frame typically serves a variable number of users. In accordance with the invention, all in-frame u-ID information is allocated at the beginning of the frame (i.e. sent earliest in the frame or just after a pilot, other reference or preamble signal). Preferably, the list of u-ID information is transmitted entirely within the first symbol 206 (if possible). If all the in-frame u-ID information cannot fit within a single symbol, than a second symbol following the first one is used to convey the remaining u-ID information. In either case, the other remaining control information portion may begin immediately after the u-ID information in the first symbol (or second symbol depending on the length of the u-ID list) or may start at the beginning at the next symbol. In the example shown in FIG. 8, the list of u-ID information is sent entirely within the first symbol 206 and the other remaining control information is sent in the second and third symbols 208. Note that the control message of the present invention can be used for any suitable type of resource. Resource examples include but are not limited to DL, UL, measurement, unicast, broadcast or any other type of resource assignment in the frame. It is noted that the transport format used in the frame may comprise any suitable format, such as taken from a set of modulation, coding and MIMO schemes.

In accordance with the invention, the first portion of the control message comprising the u-ID information enables all users (i.e. all frame recipients) to quickly determine if the remainder of the current frame (i.e. the second portion of the control message and the subsequent data portion 209 of the frame) comprises a resource assignment corresponding to a particular user. Note that the rule for mapping of u-ID information to control resources may be defined using any suitable means, such as, a formula or expression, a predetermined rule, etc. Providing a list of u-IDs involved in the current frame first enables users (i.e. receivers) to cease continued reception of the current frame if their respective user-IDs have no corresponding assignment in the current frame. This functions to minimize the number of symbols receivers not served in the current frame are required to receive and decode to only those containing the list of u-IDs involved in the frame. Thus, only those users expecting to be granted a corresponding resource in the current frame (as learned from the list of u-IDs in the first portion of the control message) need to keep their receiver circuitry powered on to receive the rest of the frame. All other users can shut their receiver circuitry down thereby significantly reducing their power consumption accordingly.

Since it is critical that the contents of the control message be received and detected reliably for purposes of accessing the system resources for receive, transmit and measurement tasks, the frame structure provides a means for providing reliable detection of the control message, especially the first portion. Such means may comprise any or all of the following protection techniques: (1) the use of well-known strong error correction codes (ECC), (2) use of error detection codes, (3) use of robust modulation schemes, (4) use of smart antenna techniques in both ends of the link (transmitter and receiver) or just in one side of the link (either transmitter or receiver), (5) use of increased relative power for the first portion only or the entire control message, (6) use of increased relative power or number of reference signals required for control message detection, (7) employing a repetition mechanism of the first portion or the entire control message, (8) use of interleaving over the first portion, (9) mapping the first portion randomly over the entire OFDM symbol; (10) use of space/time codes; and (11) use of transmit diversity.

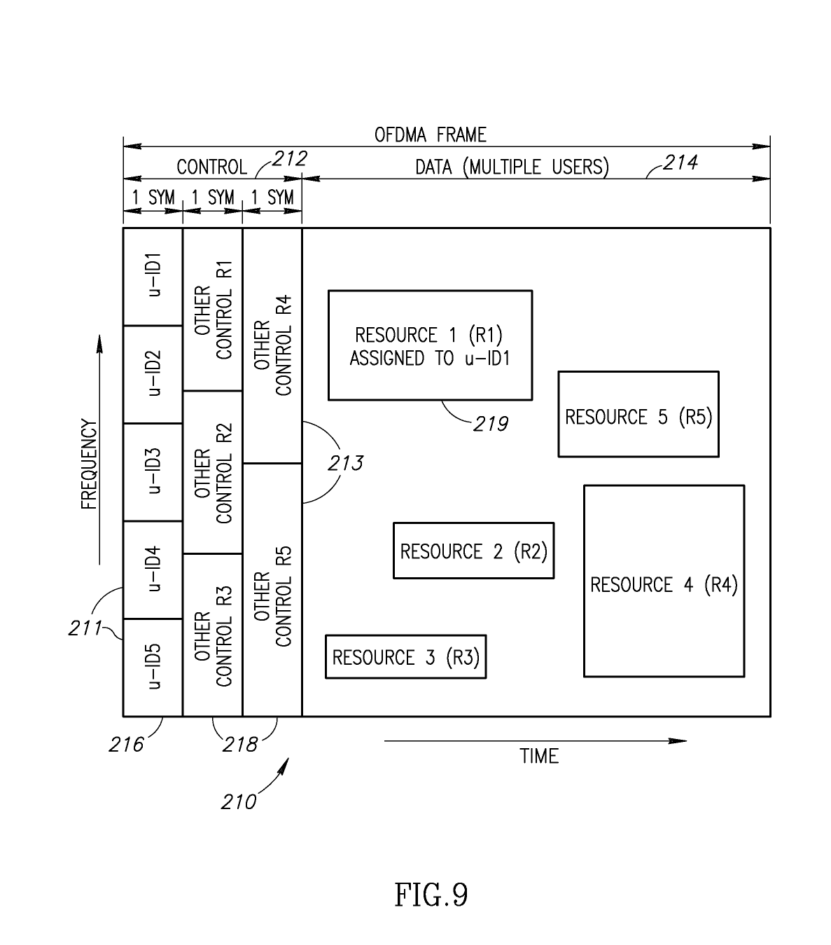

A diagram illustrating the frame structure of an example OFDMA frame adapted for use with the control channel signaling mechanism of the present invention is shown in FIG. 9.

Each frame, generally referenced 210, comprises a signaling or control portion 212 and a data portion 214. In this example, the control portion 212 comprises three symbols. The first symbol 216 comprises the first portion of the control message, namely the list of u-ID information having resource assignments in the frame. The list comprises five u-IDs 211, labeled u-ID1 through u-ID5. The second portion of the control message comprises the other remaining control information 213 for resources R1 through R5 219 sent in the data portion 214 of the frame. In this example, the other control information spans two symbols, i.e. the second and third control message symbols 218. Note that the data transmitted in the data portion of the frame may comprise any type of user data, headers, in-band control information, etc.

Note that the frame structure of FIG. 9 illustrates an OFDM or OFDMA wireless system. It is appreciated, however, that the invention is not to be limited to this wireless technology. The u-IDs are transmitted first, preferably in the first symbol of the frame thereby enabling users to perform pre-detection demodulation of the control message.

In accordance with the invention, the first symbol in the frame comprises the list of u-ID information involved in the frame. The subsequent portion of the control message comprises the remaining control information and corresponds to the resource elements sent in the data portion of the frame. It is important to note that if, for example, the wireless system serves twenty users (i.e. u-ID1 through u-ID20), wherein only five users are served in the present frame, all users are obligated to receive and decode only the first symbol of the frame. Only the five users served (i.e. have associated resources in the current frame) continue to demodulate the rest of the frame. The fifteen users that do not have assignments in the current frame can cease reception and shut off their receivers for the remainder of the frame.

It is important to note that the control message signaling mechanism described supra is applicable to transmission of DL and UL information and to both FDD and TDD systems. It is also noted that the control message signaling mechanism described supra is applicable to individual user assignments as well as for assignments to groups of users. Groups of users may have a single u-ID associated per group. A secondary method to resolve the specific ID association may or may not be employed. For example, in a unicast session each group member is obligated to access the second portion of the control message or the resource itself to associate itself with a transport element. In a broadcast session, it may not be required to resolve a specific user association since the entire group is mapped to the same resource collectively. In addition, the group may be specified by the list of all u-IDs corresponding to the users in the specific group or that have a unique u-ID for a group of services.

In one embodiment, the full u-ID information is sent in the first portion of the control message. In an alternative embodiment, abbreviated u-ID information is sent instead. For example, each u-ID may be represented by several LSB or MSB bits from its full length u-ID. In general, an other reduced u-ID bit scheme may be employed to further reduce the size of the u-ID list that must be transmitted. In addition, u-IDs may be temporarily allocated by the cell to the UEs that are currently being served. This temporary allocation may be arbitrary to the system UE ID provided by the UE manufactured or/and its SIM card. In this case, the temporary u-ID is provided by the cell to the ULE in the handover or reselection process to the cell's service coverage area. The temporal u-ID is released back to the cell pool of temporal IDs when the UE moves out of the service coverage area of the cell.

In addition to a breakdown based on word length or flat segmentation, the bit reduction may be achieved using a hierarchical approach such as assigning u-IDs utilizing a well-known tree database method. This method may also prevent unnecessary demodulation of the remainder of the frame by users that have no corresponding assignment in it. Note also that different u-ID and transport formats may be used for the DL, UL, measurements or any other type of resource allocation. Further, the u-ID list may be sorted or structured according to some criteria, enabling even greater efficiency in parsing the list to find a match in u-ID by a typical UE or by groups of UEs having particular characteristics, e.g., putting the u-IDs of higher paying customer UEs at the beginning of the list or in the first OFDM symbol, each codeword consists of abbreviated u-ID information (as described supra), etc.

The association between a specific u-ID and a corresponding resource assignment may be performed according to an association rule. In an example embodiment, the second portion of the control message may be associated on a per u-ID basis using an embedded indication in the first portion of the control message. In another embodiment, the second portion of the control message is associated with a predetermined association rule or formula indicating the corresponding position of the remainder of the control message. For example, with a constant or known control message length, the association could be based on the order of the sequence of the u-ID and transport format. An indication in the u-IDs enables the receiver to resolve between groups and specific individual assignments.

Further, the u-IDs incorporated in the first symbol(s) may be encoded either jointly or separately. In the case of separate coding, an ordered list of the u-IDs or a well known pre-defined rule is used wherein each user determines if it belongs to the set of served users via an incremental decoding of the u-ID list. Using this coding technique may result in further reductions in receiver complexity. In addition, the remaining other control information and data may be encoded either jointly or separately as well.

In another alternative embodiment, dynamic assignment of resources is performed simultaneously with pre assigned resources. The pre-assignment, performed through control messages, may be either permanent (wherein no signaling is required) or valid for a finite number of frames.

In yet another alternative embodiment, the mechanism may include retransmissions. The resources for retransmissions may be assigned through pre-assignment or through dynamic allocations. In the case of dynamic allocations, the same or different u-ID and control-message structures may be used.

In another alternative embodiment, the u-ID may be assigned to an entire cell of users or for transport of control messages. In this case, the same processing is performed for the different types of transport. This method enables a simpler design for the receiver and transmitter.

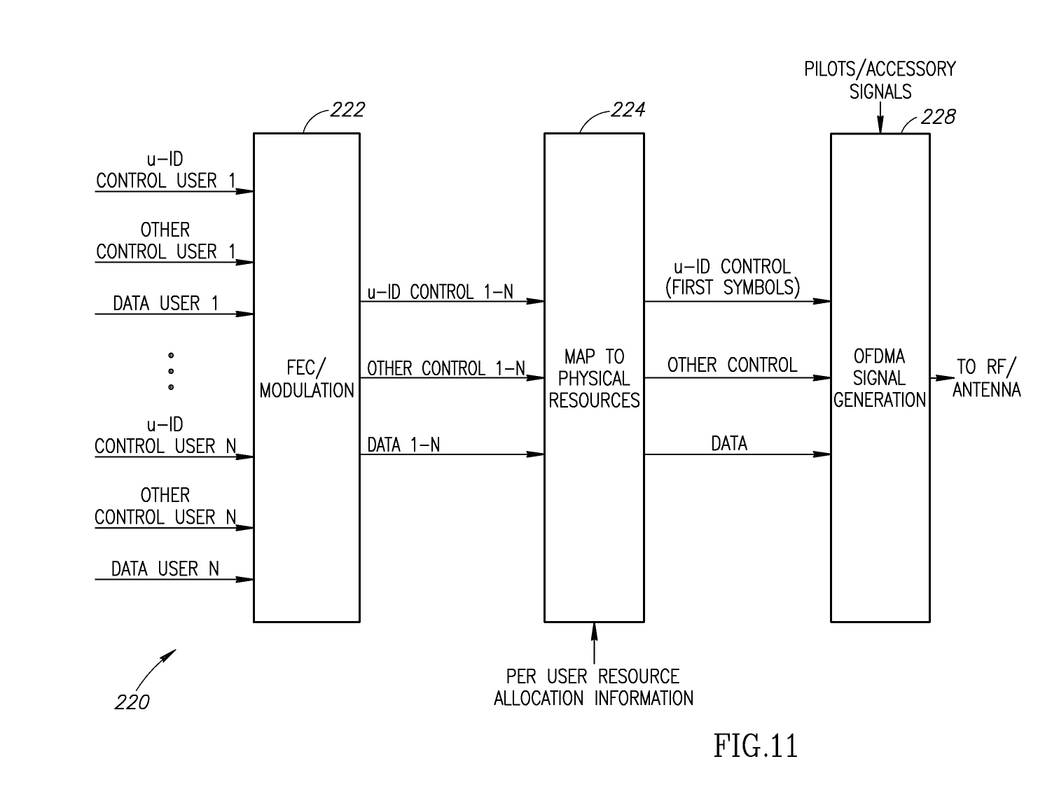

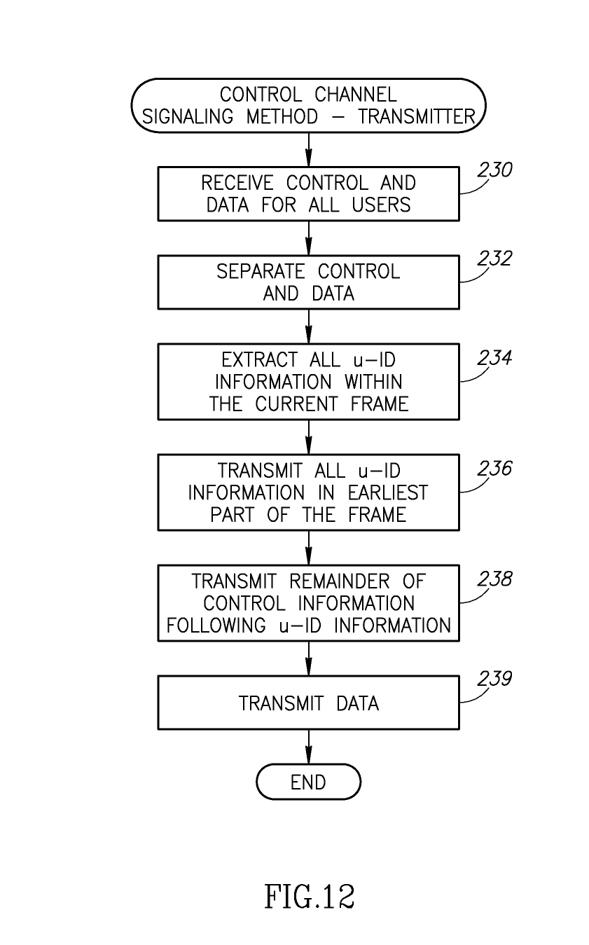

A block diagram illustrating an example OFDMA transmitter incorporating the control channel signaling mechanism of the present invention is shown in FIG. 11. A flow diagram illustrating the transmitter based control channel signaling method of the present invention is shown in FIG. 12. With reference to FIG. 11 and 12, the transmitter, generally referenced 220, comprises FEC/modulation block 222, physical resource mapper block 224 and OFDMA signal generation block 228.

In operation, user information for users 1 through N is input to the FEC/modulation block 222. The user information comprises u-ID list information, other control information and data.

The FEC/modulation block functions to apply coding and modulation to the control and data information (step 230). It is important to note that the u-ID list information is handled as a separate decodable entity in order that the receiver will be able to receive and decode it without needing to receive the remainder of the frame just to obtain FEC encoding information for the first few symbols. The control and data portions of the frame are handled separately from the u-ID list information and may or may be sent as independent decodable entities (step 232).

The u-ID list information, other control information and data output from the FEC/modulation block is mapped to physical resources via block 224 whereby resources in time and subchannel are allocated for the input streams. The list of u-ID information representing the u-IDs having corresponding resource allocations in that frame is sent in the first or earliest symbol (step 236) and the other control information is sent after the list (step 238). Data is sent after both portions of the control message are sent (step 239). Note that exactly how the other control information and data are sent in the frame is not critical to the invention. For example, the other control information and data may be sent in a shared channel, separately, combined, interleaved, etc. The control and data portions of the frame, along with pilot and various accessory signals, are input to the OFDMA signal generation block 228 which functions to generate the output OFDMA signal (i.e. perform IFFT, insert CP, etc.). This signal is output to the RF section for filtering, amplification, etc.

As described supra, the mechanism of the invention places user identification information (i.e. u-ID information) at the beginning of the control portion of a frame, e.g., in the first symbol. For most applications, all the u-ID information can be transmitted in a single symbol since each u-ID is relatively small in length with respect to the entire control message, i.e. 10 bits of u-ID to signal 1024 UEs compared to approximately 50-70 bits for the entire control message. Note that the u-ID bits may be transmitted without coding. To increase communication reliability, coding is used which causes the size of the u-IDs to double, triple, quadruple or more depending on the coding scheme used. This may cause the u-ID information to span several symbols.

Therefore, the invention provides a mechanism to shorten the size of the u-ID information. In an alternative embodiment, shortened u-IDs are used. The shortened u-ID may comprise any suitable shortening technique. For example, each u-ID may comprise only the first few LSBs or MSBs of the full u-ID which are transmitted in the first OFDM symbol. This helps non-associated users to avoid having to receive and decode the rest of the control message.

In an alternative embodiment, the network may allocate a dedicated codeword per symbol and allocate the most important u-IDs in the first symbol. The u-IDs may be allocated in accordance with some criteria of importance, e.g., contract, emergency, UEs with low battery capacity, etc. In this embodiment, the frame structure would be modified to support multiple u-ID lists.

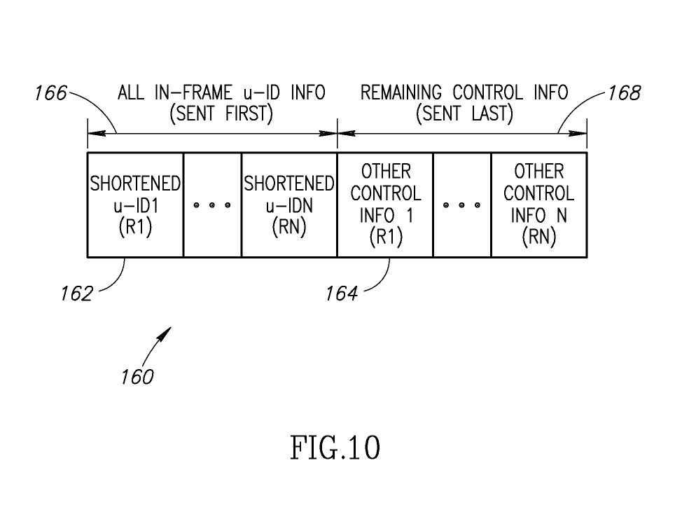

A diagram illustrating a second structure of the control message of the present invention in more detail is shown in FIG. 10. The control message, generally referenced 160, comprises two portions: a list of all the in-frame u-ID information 166 and the remaining control information 168.

The plurality of u-IDs 162 are transmitted together in serial fashion one after the other in the first part of the frame (i.e. sent earliest). Here, however, shortened u-IDs are transmitted.

The remaining control information 164 (e.g., resource related information) is transmitted subsequent to the u-ID information 166 (i.e. sent subsequent to the first portion or latest in time within the control message). Each of the u-IDs corresponds to a resource (e.g., R1 through RN) that is sent in the current frame.

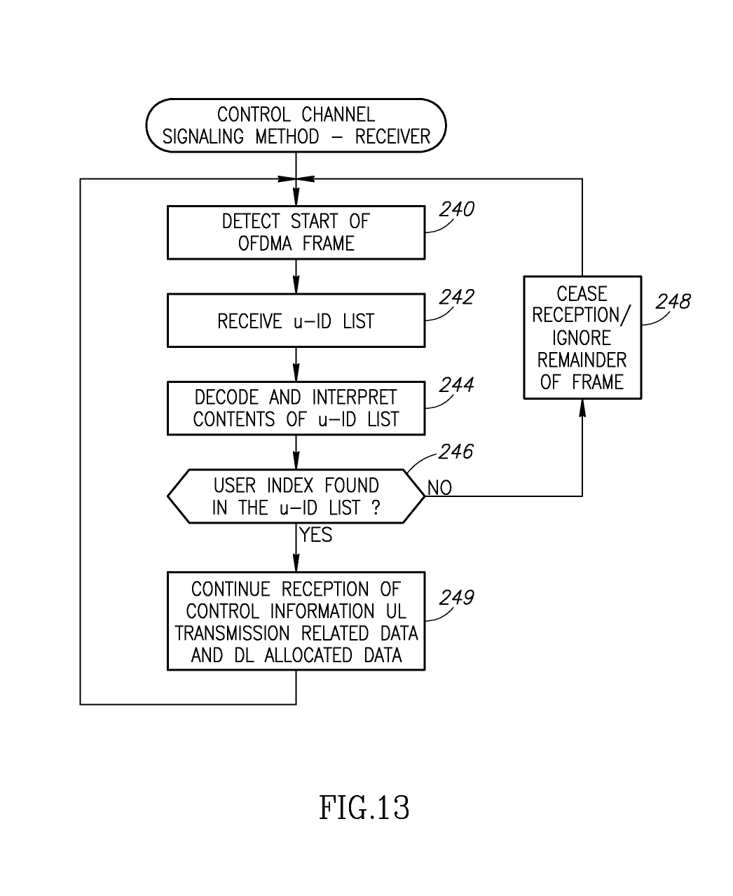

A flow diagram illustrating the receiver based control channel signaling method of the present invention is shown in FIG. 13. The receiver first detects the start of the OFDM frame (step 240). It then receives the first or earliest symbol comprising the u-ID list (step 242). The contents of the list are then decoded and interpreted (step 244) to determine whether the u-ID corresponding to the receiver is found in the list (step 246). If it is, the receiver continues receiving and decoding the remainder of the control message, the appropriate portions of the data portion of the frame and the UL transmitted data (step 249). If the u-ID of the receiver is not found in the list (step 246), then the receiver ceases reception, shuts off its receiver circuit and ignores the remainder of the frame including ceasing any UL transmission, thereby significantly reducing power consumption (step 248).

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of control channel signaling for use in a transmitter, said method comprising the step of:
transmitting user-ID information addressed in a current frame as a decodable entity at the beginning of said current frame thereby enabling receivers to cease continued reception of said current frame if their respective user-IDs have no corresponding assignment therein.

2. The method according to claim 1, wherein said user-ID information is sent in a list encoded into one or more codewords.

3. The method according to claim 1, further comprising the step of encoding other control information and data jointly into one or more codewords that are transmitted subsequent to said user-ID information.

4. The method according to claim 1, further comprising the step of protecting said user-ID information before transmission thereof.

5. The method according to claim 1, wherein said user-ID information is transmitted in a first symbol of said frame.

6. The method according to claim 1, wherein said user-ID information is sent in a list structured in accordance with a criteria.

7. A method of control channel signaling for use in a transmitter, said method comprising the steps of:
first transmitting a list of all user-ID information addressed in a current frame as a first decodable entity encoded into one or more codewords sent at the beginning of said current frame;
second transmitting other control information for said current frame as one or more second decodable entities encoded into one or more codewords sent subsequent to said first decodable entity; and
third transmitting other data subsequent to said one or more second decodable entities.

8. The method according to claim 7, wherein transmitting said list as said a first decodable entity in said frame enables receivers to cease continued reception of said current frame if their respective user-IDs have no corresponding assignment in said frame.

9. The method according to claim 7, further comprising the step of protecting said user-ID information before transmission thereof.

10. The method according to claim 7, wherein said list of user-ID information is transmitted in a first symbol of said current frame.

11. The method according to claim 7, wherein said user-ID information is sent in a list structured in accordance with a criteria.

12. A method of control channel signaling for use in a receiver, said method comprising the steps of:
receiving a list of user-ID information addressed in a current frame as a first decodable entity encoded into one or more codewords sent at the beginning of said current frame; and
continuing to receive said current frame if a corresponding user-ID assignment is found in said list, otherwise ceasing reception of said current frame.

13. The method according to claim 12, wherein ceasing reception of said current frame when a corresponding user-ID assignment is not found in said list results in a significant reduction in power consumption in said receiver.

14. The method according to claim 12, further comprising the step of protecting said user-ID information before transmission thereof.

15. The method according to claim 12, wherein said list of user-ID information is received spread over an entire first symbol of said current frame.

16. The method according to claim 12, wherein said user-ID information is sent in a list structured in accordance with a criteria.

17. A radio, comprising:
a transmitter;
a receiver;
a baseband processor coupled to said transmitter and said receiver; and
a control channel signaling unit coupled to said transmitter and operative to transmit user-ID information addressed in a current frame as a decodable entity at the beginning of said current frame thereby enabling said receiver to cease continued reception of said current frame if its respective user-ID has no corresponding assignment therein.

18. The radio according to claim 17, further comprising the step of encoding other control information and data either jointly or separately into one or more codewords that are transmitted subsequent to said user-ID information.

19. The radio according to claim 17, wherein said user-ID information is transmitted as a list spread over an entire first symbol of said frame.

20. The radio according to claim 17, wherein said control channel signaling unit is operative to enable said receiver to cease uplink (UL) transmission of data for said current frame if its respective user-ID has no corresponding assignment therein.

21. A radio, comprising:
a transmitter;
a receiver;
a baseband processor coupled to said transmitter and said receiver;
a control channel signaling unit coupled to said receiver and operative to:
receive a list of all user-ID information addressed in a current frame as a first decodable entity encoded into one or more codewords sent at the beginning of said current frame; and
continue to receive said current frame if a corresponding user-ID assignment is found in said list, otherwise ceasing reception of said current frame.

22. The radio according to claim 21, further comprising the step of encoding other control information and data either jointly or separately into one or more codewords that are transmitted jointly in a shared channel subsequent to said first decodable entity.

23. The radio according to claim 21, wherein ceasing reception of said current frame when a corresponding user-ID assignment is not found in said list results in a significant reduction in power consumption in said radio.

24. The radio according to claim 21, wherein said user-ID information is transmitted as a list spread over an entire first symbol of said frame.

25. The radio according to claim 21, wherein said control channel signaling unit is operative to cease uplink (UL) transmission of data for said current frame if said corresponding user-ID assignment is not found in said list.
